(19) United States
(12) Patent Application Publication
(10) Pub. No.: US 2025/0149202 A1
(43) Pub. Date: May 8, 2025

(54) MAGNET WIRE

(71) Applicant: SUMITOMO ELECTRIC INDUSTRIES, LTD., Osaka (JP)

(72) Inventors: Shinichi IIZUKA, Osaka (JP); Soichiro OKUMURA, Osaka (JP); Shinichi KANAZAWA, Osaka (JP); Yusuke SAKAMOTO, Osaka (JP); Shinnosuke NAKAJIMA, Osaka (JP); Naoki SUGIHARA, Osaka (JP); Kazuaki IKEDA, Osaka (JP); Makoto NAKABAYASHI, Osaka (JP)

(73) Assignee: SUMITOMO ELECTRIC INDUSTRIES, LTD., Osaka (JP)

(21) Appl. No.: 18/833,887

(22) PCT Filed: Oct. 17, 2022
(86) PCT No.: PCT/JP2022/038626

§ 371 Date: Jul. 27, 2024

(30) Foreign Application Priority Data
Feb. 1, 2022 (JP) 2022-014109

(51) Int. Cl. H01B 7/02; H01B 3/42

(52) U.S. Cl. CPC H01B 7/0225; H01B 3/427; H01B 7/0216

(57) ABSTRACT

A magnet wire according to an aspect of the present disclosure is a magnet wire comprising a conductor and a plurality of insulating layers covering the conductor, wherein the insulating layers have an innermost layer and an outermost layer, a main component of the innermost layer is a fluororesin, and a ratio E1/E2 of a Young's modulus E1 of the outermost layer to a Young's modulus E2 of the innermost layer is 1.1 or more.

### TECHNICAL FIELD

The present disclosure relates to a magnet wire.

The present application claims the benefit of priority to Japanese Patent Application No. 2022-014109 filed on Feb. 1, 2022, the entire contents of which are incorporated herein by reference.

### BACKGROUND ART

PTL 1 recites an insulated electric wire (a magnet wire) useful for coil winding, characterized in that the insulated electric wire comprises a conductor, a coating layer provided on the conductor and formed by crosslinking treatment of a fused fluororesin composition, and a film layer provided on the outside of the coating layer and formed by baking a heat-resistant insulating coating material.

### CITATION LIST

### Patent Literature

PTL 1: Japanese Utility Model Laying-Open No. S63-168923

### SUMMARY OF INVENTION

A magnet wire according to an aspect of the present disclosure is a magnet wire comprising a conductor and a plurality of insulating layers covering the conductor, wherein the insulating layers have an innermost layer and an outermost layer, a main component of the innermost layer is a fluororesin, and a ratio E1/E2 of a Young's modulus E1 of the outermost layer to a Young's modulus E2 of the innermost layer is 1.1 or more.

### BRIEF DESCRIPTION OF DRAWINGS

FIG. 1 is a schematic cross-sectional view illustrating a magnet wire according to a first embodiment of the present disclosure.

FIG. 2 is a schematic cross-sectional view illustrating a magnet wire according to a second embodiment of the present disclosure.

### DETAILED DESCRIPTION

### Problem to be Solved by the Present Disclosure

An object of the present disclosure is to provide a magnet wire with excellent workability.

### Advantageous Effect of the Present Disclosure

A magnet wire according to an aspect of the present disclosure has excellent workability.

### DESCRIPTION OF EMBODIMENTS

First, aspects of the present disclosure will be described below.

A magnet wire according to an aspect of the present disclosure is a magnet wire comprising a conductor and a plurality of insulating layers covering the conductor, wherein the insulating layers have an innermost layer and an outermost layer, a main component of the innermost layer is a fluororesin, and a ratio E1/E2 of a Young's modulus E1 of the outermost layer to a Young's modulus E2 of the innermost layer is 1.1 or more.

With the main component of the innermost layer being a fluororesin and the ratio E1/E2 being 1.1 or more, the magnet wire has excellent workability.

Preferably, the ratio ε1/ε of the relative permittivity al of the outermost layer to the relative permittivity ε of the insulating layers as a whole is from 1.1 to 2.0. In this case, workability of the magnet wire can be further enhanced.

Preferably, the main component of the outermost layer is polyimide, polyamide-imide, polyether ether ketone, polyphenylene sulfide, or a combination of these. In this case, adhesion to a coil-securing material such as impregnation varnish and/or molding resin can be enhanced.

Preferably, at least one of the innermost layer and the outermost layer may contain silica. In this case, the Young's modulus can be enhanced.

Preferably, the insulating layers further have an intermediate layer between the outermost layer and the innermost layer. In this case, the difference in thermal expansivity between the outermost layer and the innermost layer can be reduced, and application properties at the time of formation of the outermost layer by varnish application can be enhanced, among others.

Preferably, the intermediate layer may contain silica. In this case, workability and insulating properties are excellently balanced.

Preferably, the magnet wire is a rectangular wire. In this case, the magnet wire can be wound at a high density.

### DETAILED DESCRIPTION OF EMBODIMENTS

In the following, detailed description will be given of a magnet wire according to an embodiment of the present disclosure, referring to drawings.

### First Embodiment

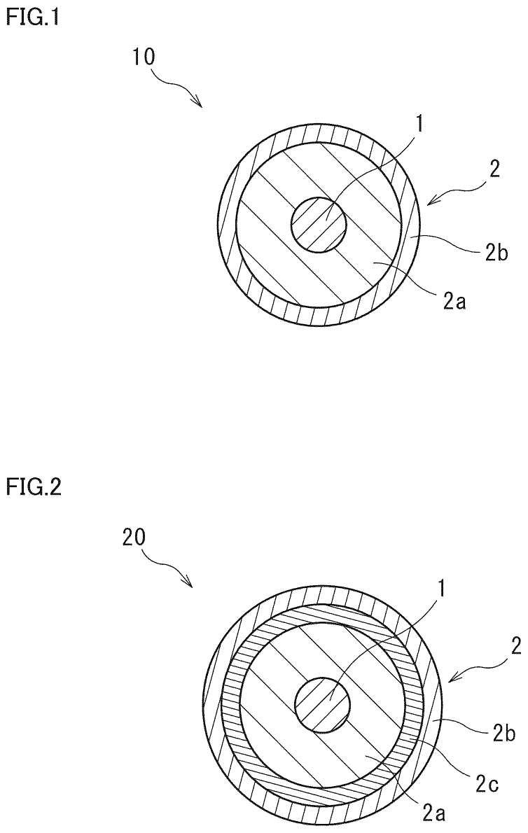

A magnet wire 10 in FIG. 1 comprises a conductor 1 and a plurality of insulating layers 2 covering conductor 1. Insulating layers 2 comprise an innermost layer 2a and an outermost layer 2b.

The cross-sectional profile of magnet wire 10 is not particularly limited, and, for example, it may be circular (a round wire), elliptical, square (a square wire), or rectangular (a rectangular wire). Preferably, the cross-sectional profile of magnet wire 10 is rectangular, which means that magnet wire 10 is a rectangular wire. In this case, magnet wire 10 can be wound at a high density at the time when it is wound into a coil. It is preferable that the cross-sectional profile of magnet wire 10 is the same shape as the cross-sectional profile of conductor 1 described below.

Magnet wire 10 is suitable for coil winding.

In the following, the configuration of magnet wire 10 will be described.

### [Conductor]

As conductor 1, a linear conductor can be used. Examples of the linear conductor include metal wires such as copper wire, tin-plated copper wire, aluminum wire, aluminum alloy wire, steel-cored aluminum wire, copper fly line, nickel-plated copper wire, silver-plated copper wire, and copper-covered aluminum wire.

The cross-sectional profile of conductor 1 may be circular (a round wire), elliptical, square, rectangular, and/or the like, for example. When magnet wire 10 is a rectangular wire, the cross-sectional profile of conductor 1 is preferably rectangular.

The lower limit to the average cross-sectional area of conductor 1 is preferably 0.01 mm², more preferably 0.1 mm². The upper limit to the average cross-sectional area is preferably 15 mm², more preferably 10 mm².

### [Insulating Layer]

There are a plurality of insulating layers 2. “A plurality of insulating layers” means a plurality of insulating layers that are different in the Young's modulus. For example, when insulating layers 2 of magnet wire 10 are formed by a below-described method (a method that involves repeating varnish application and baking multiple times), insulating layers formed with the same type of varnish are regarded as the same insulating layers.

Insulating layers 2 are stacked on the circumferential surface of conductor 1 to cover conductor 1. Insulating layers 2 comprise innermost layer 2a stacked on the circumferential surface of conductor 1, and outermost layer 2b stacked on the outside of innermost layer 2a. Among the plurality of insulating layers, the side close to the conductor is called the “inner” side, and the side opposite to the “inner” side is called the “outer” side. Among the plurality of insulating layers, the layer stacked on the innermost side is called the innermost layer, the layer stacked on the outermost side from the conductor is called the outermost layer, and any layer present between the innermost layer and the outermost layer is called an intermediate layer.

The main component of the innermost layer in magnet wire 10 is a fluororesin, and the ratio E1/E2 of the Young's modulus E1 of the outermost layer to the Young's modulus E2 of the innermost layer is 1.1 or more. With this configuration, magnet wire 10 has excellent workability. The reason is not clear, but it is conjectured as follows, for example. At the time of working a magnet wire, if the thickness of insulating layers decreases (namely, if the insulating layers are partly chipped or peeled off), insulation breakdown can occur. The decrease of thickness of insulating layers can be inhibited by reducing the friction resistance of the insulating layers. Attention can be paid to the Young's moduli of the outermost layer and the innermost layer of the insulating layers, and the Young's modulus of the outermost layer can be set higher than the Young's modulus of the innermost layer by at least a certain margin, and, as a result, at the time when the insulating layers receive force at a point of contact with a work jig, for example, the innermost layer having a relatively low Young's modulus can preferentially undergo elastic deformation, which can inhibit a contact-area increase or adhesion that may occur due to film deformation near the point of contact between the outermost layer having a relatively high Young's modulus and the work jig, potentially causing a decrease of friction resistance. The “Young's modulus” is a Young's modulus of the magnet wire from which the conductor was removed, measured at 20° C. by a method in accordance with JIS K 7161-1:2014.

The lower limit to the ratio E1/E2 is preferably 1.8, more preferably 3.0, further preferably 3.5, further more preferably 4.0, particularly preferably 5.0, most preferably 5.5. With the ratio E1/E2 being equal to or more than the above-mentioned lower limit, workability can be further enhanced. Unless otherwise specified, in the description of this specification regarding an upper limit and a lower limit of a numerical range, the upper limit may be either “equal to or less than” or “less than”, and the lower limit may be either “equal to or more than” or “more than”.

The upper limit to the ratio E1/E2 is 100, for example.

The upper limit to the relative permittivity ε of the insulating layers as a whole is preferably 3.0, more preferably 2.8, further preferably 2.6. In this case, insulating properties of the magnet wire can be further enhanced. The lower limit to the relative permittivity ε is 1.0, for example, preferably 1.5, more preferably 2.0. The “relative permittivity” is a value that is measured in accordance with JIS K 2935-2:1999, under the conditions of 60 Hz and room temperature (25° C.).

The average thickness T of insulating layers 2 as a whole is not particularly limited, and, for example, it can be from 20 μm to 200 μm.

### (Innermost Layer)

Innermost layer 2a is a layer that is stacked on the innermost side among the plurality of insulating layers. In other words, innermost layer 2a is a layer that is stacked closest to conductor 1 among the plurality of insulating layers. Preferably, innermost layer 2a is a layer that directly covers conductor 1.

The Young's modulus E2 of innermost layer 2a is not particularly limited as long as it satisfies the above-mentioned range of the ratio E1/E2. The lower limit to the Young's modulus E2 is preferably 100 MPa, more preferably 200 MPa, further preferably 300 MPa. The upper limit to the Young's modulus E2 is preferably 1,500 MPa, more preferably 1,400 MPa, further preferably 1,300 MPa. With the Young's modulus E2 falling within the above-mentioned range, at the time when force is applied to a point of contact between the insulating layers and a coil-work jig, for example, innermost layer 2a can even more preferentially undergo elastic deformation, and, as a result, friction resistance of the insulating layers can decrease to give further excellent workability.

The main component of innermost layer 2a is a fluororesin. With the main component of innermost layer 2a being a fluororesin, magnet wire 10 can exhibit excellent insulating properties. The “main component” refers to a component that has the highest content in terms of mass. The “fluororesin” refers to one in which at least one hydrogen atom bonded to a carbon atom of a repeating unit of the polymer chain is replaced by a fluorine atom or an organic group having a fluorine atom (hereinafter also called “a fluorine-atom-containing group”). The fluorine-atom-containing group is a group in which at least one hydrogen atom in the linear or branched organic group is replaced by a fluorine atom, and examples thereof include fluoroalkyl group, fluoroalkoxy group, and fluoropolyether group.

Examples of the fluororesin include polytetrafluoroethylene (PTFE), tetrafluoroethylene-(perfluoroalkyl vinyl ether) copolymer (PFA), tetrafluoroethylene-hexafluoropropylene copolymer (FEP), polychlorotrifluoroethylene (PCTFE), tetrafluoroethylene-ethylene copolymer (ETFE), and chlorotrifluoroethylene-ethylene copolymer (ECTFE). Only one type of fluororesin may be used alone, or two or more types may be used in combination.

Although a fluororesin is generally categorized as a crystalline resin, as the fluororesin, not only a crystalline fluororesin but also an amorphous fluororesin may be used.

As the fluororesin, PTFE, PFA, or FEP is preferable, and PTFE is more preferable. In this case, insulating properties of magnet wire 10 can be further enhanced. When PTFE is used, due to its low water absorption, resistance to moist heat can be enhanced.

Examples of the PTFE include crosslinked PTFE obtained by the method described in International Patent Laying-Open No. WO 2017/043372. This document recites a method for producing a crosslinked PTFE having a number average molecular weight of 600,000 or less, by irradiating PTFE having a melt viscosity at 380° C. from 1×10⁵ Pa·s to 7×10⁵ Pa·s with an ionizing ray.

Innermost layer 2a may contain other components except the main component. Examples of these other components include fillers such as silica, alumina, magnesium oxide, beryllium oxide, silicon carbide, titanium carbide, boron carbide, tungsten carbide, boron nitride, and silicon nitride. With innermost layer 2a containing silica, the Young's modulus E2 can be enhanced.

The lower limit to the average thickness T2 of innermost layer 2a is preferably 20 μm. The upper limit to the average thickness T2 of innermost layer 2a is preferably 150 μm. The “average thickness” refers to the average value of thicknesses at any 10 points.

Innermost layer 2a preferably has low permittivity. In this case, it can be suitably used even in a high-voltage apparatus, without needing excessively increasing the film thickness. Moreover, the relative permittivity ε2 of innermost layer 2a is preferably less than the relative permittivity ε1 of outermost layer 2b, which is to be described below. The upper limit to the relative permittivity ε2 of innermost layer 2a is preferably 2.8, more preferably 2.6, further preferably 2.4. In this case, insulating properties of magnet wire 10 can be further enhanced. The lower limit to the relative permittivity of innermost layer 2a is preferably 1.8.

### (Outermost Layer)

Outermost layer 2b is a layer that is stacked on the outermost side among the plurality of insulating layers 2. In other words, outermost layer 2b is a layer that is stacked farthest from conductor 1 among the plurality of insulating layers 2. Outermost layer 2b is different from innermost layer 2a.

The Young's modulus E1 of outermost layer 2b is not particularly limited as long as it satisfies the above-mentioned range of the ratio E1/E2, and it can be determined as appropriate relative to the Young's modulus E2. The lower limit to the Young's modulus E1 is preferably 550 MPa, more preferably 600 MPa, further preferably 1,000 MPa, and sometimes it may be preferably 2,000 MPa and/or 2,500 MPa. The upper limit to the Young's modulus E1 is preferably 10,000 MPa, more preferably 4,500 MPa. With the Young's modulus E1 falling within the above-mentioned range, friction resistance between the insulating layers and a coil-work jig can be decreased.

The main component of outermost layer 2b is not particularly limited as long as it is a synthetic resin having insulating properties and satisfies the above-mentioned range of the ratio E1/E2, and it can be determined as appropriate in relation to innermost layer 2a. Examples of the main component of outermost layer 2b include fluororesin, polyimide (PI), polyamide-imide (PAI), polyether ether ketone (PEEK), and polyphenylene sulfide (PPS) as described above, and the like. Preferably, the main component of outermost layer 2b is polyimide, polyamide-imide, polyether ether ketone, polyphenylene sulfide, or a combination of these. Generally, when a magnet wire is used to produce a coil, the magnet wire is wound around a core, and then impregnation varnish is applied to gaps between turns of the magnet wire and to gaps between the magnet wire and the core to fix turns of the magnet wire to each other and to fix the magnet wire with the core. When the main component of outermost layer 2b is a component as described above, adhesion force to the impregnation varnish can be enhanced.

Outermost layer 2b may contain other components except the main component. Examples of these other components include fillers such as silica, alumina, magnesium oxide, beryllium oxide, silicon carbide, titanium carbide, boron carbide, tungsten carbide, boron nitride, and silicon nitride. With outermost layer 2b containing silica, the Young's modulus E1 can be enhanced.

The lower limit to the arithmetic mean height Sa of outermost layer 2b is preferably 4 μm, more preferably 4.1 μm, further preferably 4.2 μm, particularly preferably 4.3 μm. The upper limit to the arithmetic mean height Sa of outermost layer 2b is preferably 6 μm, more preferably 5.8 μm, further preferably 5.7 μm, particularly preferably 5.6 μm. With the arithmetic mean height Sa of outermost layer 2b falling within the above-mentioned range, workability of magnet wire 10 can be further enhanced. The arithmetic mean height Sa represents the average of absolute values of height difference between each of multiple points and a mean plane of the surface, and is a value measured by a method in accordance with JIS B 0681-2:2018.

The root-mean-cube height Ssk of outermost layer 2b is preferably from 0.2 to 0.4. The root-mean-cube height Ssk represents the symmetry of height distribution, and is a value measured by a method in accordance with JIS B 0681-2:2018.

The expanded area ratio Sdr of interface of outermost layer 2b is preferably from 0.27 to 0.30. The expanded area ratio Sdr of interface represents the increment of the expanded area (the surface area) of a target region relative to the area of the target region, and is a value measured by a method in accordance with JIS B 0681-2:2018.

The lower limit to the arithmetic mean peak curvature Spc of outermost layer 2b is preferably 150, more preferably 160, further preferably 170. The upper limit to the arithmetic mean peak curvature Spc of outermost layer 2b is preferably 250, more preferably 220, further preferably 200. With the arithmetic mean peak curvature Spc of outermost layer 2b falling within the above-mentioned range, workability of magnet wire 10 can be further enhanced. The arithmetic mean peak curvature Spc represents the average of the principal peak curvature of the surface, and is a value measured by a method in accordance with ISO 25178-2:2012.

The lower limit to the average thickness T1 of outermost layer 2b is preferably 1 μm. The upper limit to the average thickness T1 of outermost layer 2b is preferably 10 μm.

The average thickness T1 of outermost layer 2b is preferably less than the average thickness T2 of innermost layer 2a. In this case, the function of outermost layer 2b can be exhibited without impairing the function of innermost layer 2a. The ratio T1/T2 of the average thickness T1 of outermost layer 2b to the average thickness T2 of innermost layer 2a is preferably 0.1 or less.

The ratio T1/T of the average thickness T1 of outermost layer 2b to the average thickness T of insulating layers 2 is preferably from 0.1 to 0.2.

Outermost layer 2b preferably has low permittivity. The upper limit to the relative permittivity ε1 of outermost layer 2b is preferably 4.5, more preferably 4.2. In this case, insulating properties of magnet wire 10 can be further enhanced. The lower limit to the relative permittivity ε1 of outermost layer 2b is preferably 2.0.

The ratio ε1/ε of the relative permittivity ε1 of outermost layer 2b to the relative permittivity ε of insulating layers 2 as a whole is preferably from 1.1 to 2.0. In this case, workability of magnet wire 10 can be further enhanced. The upper limit to the ratio ε1/ε is more preferably 1.8, further preferably 1.6, further more preferably 1.4.

### Second Embodiment

A magnet wire 20 in FIG. 2 comprises conductor 1 and a plurality of insulating layers 2 covering conductor 1. Insulating layers 2 comprise innermost layer 2a, outermost layer 2b, and an intermediate layer 2c. The configurations of conductor 1, innermost layer 2a, and outermost layer 2b are the same as those in the first embodiment described above, so the same reference numerals are used and explanation is omitted.

### (Intermediate Layer)

Intermediate layer 2c is a layer that is present between innermost layer 2a and outermost layer 2b. With magnet wire 20 comprising intermediate layer 2c, the difference in thermal expansivity between innermost layer 2a and outermost layer 2b can be reduced, and thereby, breakage of insulating layers 2 in a heat cycle and the like can be reduced.

The Young's modulus E3 of intermediate layer 2c is not particularly limited, and it is preferably not less than E2 and not more than E1, more preferably more than E2 and less than E1. In this case, workability can be further enhanced.

The main component of intermediate layer 2c is not particularly limited, and it may include only one of the main component of innermost layer 2a and the main component of outermost layer 2b, or may include both the main component of innermost layer 2a and the main component of outermost layer 2b. Preferably, the main component of intermediate layer 2c includes both the main component of innermost layer 2a and the main component of outermost layer 2b. In this case, it can be made to function as a primer layer capable of enhancing adhesion between innermost layer 2a and outermost layer 2b. Also, it is particularly advantageous because a fluororesin as the main component of innermost layer 2a is highly water-repellent and, thereby, application properties at the time of formation of outermost layer 2b by varnish application is enhanced.

Intermediate layer 2c may contain other components except the main component. Examples of these other components include fillers such as silica, alumina, magnesium oxide, beryllium oxide, silicon carbide, titanium carbide, boron carbide, tungsten carbide, boron nitride, and silicon nitride. With intermediate layer 2c containing silica, workability and insulating properties are excellently balanced.

The lower limit to the average thickness T3 of intermediate layer 2c is preferably 5 μm. The upper limit to the average thickness T3 of intermediate layer 2c is preferably 20 μm, more preferably 10 μm.

Preferably, the average thickness T3 of intermediate layer 2c is not less than the average thickness T1 of outermost layer 2b and less than the average thickness T2 of innermost layer 2a. In this case, workability can be enhanced and also permittivity can be reduced.

Intermediate layer 2c preferably has low permittivity. Preferably, the relative permittivity ε3 of intermediate layer 2c is more than the relative permittivity ε2 of innermost layer 2a and less than the relative permittivity ε1 of outermost layer 2b. In this case, permittivity of insulating layers 2 as a whole can be reduced. The upper limit to the relative permittivity ε3 of intermediate layer 2c is preferably 4.2. The lower limit to the relative permittivity ε3 of the intermediate layer is preferably 2.1.

When magnet wire 20 comprises two or more intermediate layers 2c, it is preferable that the two or more intermediate layers 2c have a configuration where the relative permittivity increases from the side close to innermost layer 2a toward outermost layer 2b.

### [Method of Producing Magnet Wire]

The method of producing magnet wire 20 is not particularly limited, and, for example, each of innermost layer 2a, intermediate layer 2c, and outermost layer 2b may be formed by repeating varnish application and baking multiple times.

### Examples

In the following, a more detailed description will be given of the present invention with reference to examples. However, the present invention is not limited to these examples.

### <Production of Magnet Wire>

### [Conductor]

For use as a conductor, a conductor with a diameter of 2.0 mm in conformity with the annealed copper wire for electrical purposes of JIS C 3102:1984 was prepared, rinsed on the surface, and annealed in a nitrogen atmosphere.

### [Preparation of Varnish]

Varnish for forming the insulating layers specified below in Table 1 was prepared. Abbreviations of the materials are as follows.
PTFE: Polytetrafluoroethylene
PFA: Tetrafluoroethylene-(perfluoroalkyl vinyl ether) copolymer
PI: Polyimide
PAI: Polyamide-imide

### (PTFE1)

A thickener (“Metolose” from Shin-Etsu Chemical Co., Ltd.) was added to amorphous PTFE powder (“AF2400X” from Chemours-Mitsui Fluoroproducts Co., Ltd.), and the resultant was dispersed in water to prepare “PTFE1”.

### (PTFE2)

The above-mentioned thickener was added to crystalline PTFE powder (“Lubron L5” from Daikin Industries), and the resultant was dispersed in water to prepare “PTFE2”.

### (PFA Silicas 1 to 4)

Hydrophilic silica fine powder (“AEROSIL 300” from Nippon Aerosil Co., Ltd.) was added to PFA dispersion (“AD2-CRER” from Daikin Industries), and the resultant was stirred to prepare “PFA silicas 1 to 4”. In the PFA silicas 1 to 4, the amount (parts by mass) of silica relative to 100 parts by mass of PFA was adjusted; the amount (parts by mass) of silica relative to 100 parts by mass of PFA was 10 parts by mass for the PFA silica 1, 20 parts by mass for the PFA silica 2, 30 parts by mass for the PFA silica 3, and 40 parts by mass for the PFA silica 4.

### (PI)

As “PI”, polyimide varnish (“Pyre-M.L.” from I.S.T. Corporation) was used.

### (PTFE+PI)

The PTFE2 prepared in the above manner and the PI were mixed and stirred in such a manner that 50 parts by mass of polyimide resin was included relative to 100 parts by mass of fluororesin, and thereby “PTFE+PI” was prepared.

### (PTFE+Binder)

As “PTFE+binder”, dispersion of PTFE and a binder resin (“EK-1959S21R” from Daikin Industries) was used.

### [Formation of Insulating Layer]

The varnish prepared in the above manner was used, and varnish application and baking were carried out in such a manner that the layer configuration specified in Table 1 below was achieved, and thereby insulating layers were formed, and thus magnet wires of Nos. 1 to 8 were produced.

### <Evaluation>

The magnet wires produced in the above manner were evaluated in terms of insulating properties and workability, by the methods described below. Results are given in Table 1 below.

### [Insulating Properties]

Two magnet wires produced in the above manner were twisted together under a load of 1.5 kg to form a stranded wire, and alternating-current voltage was applied between both ends of the resulting stranded wire and increased at 10 V/second; the voltage at which discharging at 50 pC or more continued for 3 seconds (partial discharge inception voltage, PDIV) was measured. Insulating properties were rated as “good” when PDIV was equal to or above 800 V, and rated as “poor” when it was below 800 V.

### [Workability]

PDIV was measured in the same manner as in [Insulating Properties] above except that two magnet wires produced in the above manner were twisted together under a load of 10 kg. This test was performed as a simulation of large load application to the magnet wire. Workability was rated as “good” when PDIV was above 750 V, and rated as “poor” when it was below 750 V.

TABLE 1

| | | No. 1 | No. 2 | No. 3 | No. 4 | No. 5 | No. 6 | No. 7 | No. 8 |
|---|---|---|---|---|---|---|---|---|---|
| Innermost | Material | PTFE1 | PTFE2 | PFA silica 4 | PTFE2 | PTFE2 | PTFE2 | PTFE2 | PI |
| layer | Young's modulus | 500 | 500 | 680 | 500 | 500 | 500 | 500 | 2800 |
| | E2 [MPa] | | | | | | | | |
| | Relative | 1.9 | 2.1 | 2.6 | 2.1 | 2.1 | 2.1 | 2.1 | 3.0 |
| | permittivity ε2 | | | | | | | | |
| | (25° C.) | | | | | | | | |
| | Thickness T2 [μm] | 40 | 40 | 45 | 40 | 40 | 40 | 50 | 50 |
| Intermediate | Material | — | PFA silica 3 | — | — | PTFE + PI | PTFE + binder | — | — |
| layer | Young's modulus | — | 640 | — | — | 1600 | 1500 | — | — |
| | E3 [MPa] | | | | | | | | |
| | Relative | — | 2.6 | — | — | 2.4 | 2.5 | — | — |
| | permittivity ε3 | | | | | | | | |
| | (25° C.) | | | | | | | | |
| | Thickness T3 [μm] | — | 5 | — | — | 5 | 5 | — | — |
| Outermost | Material | PFA silica 1 | PFA silica 2 | PI | PFA silica 3 | PI | PAI | — | — |
| layer | Young's modulus | 550 | 590 | 2800 | 640 | 2800 | 2800 | — | — |
| | E1 [MPa] | | | | | | | | |
| | Relative | 2.2 | 2.4 | 3.0 | 2.5 | 3.0 | 4.2 | — | — |
| | permittivity ε1 | | | | | | | | |
| | (25° C.) | | | | | | | | |
| | Thickness T1 [μm] | 10 | 5 | 5 | 10 | 5 | 5 | — | — |

| | | | | | | | | |
|---|---|---|---|---|---|---|---|---|
| Relative permittivity ε (25° C.) | 2.0 | 2.1 | 2.6 | 2.2 | 2.2 | 2.3 | 2.1 | 3.0 |
| Young's modulus ratio E1/E2 | 1.1 | 1.2 | 4.1 | 1.3 | 5.6 | 5.6 | 1.0 | 1.0 |
| Permittivity ratio ε1/ε | 1.1 | 1.1 | 1.2 | 1.1 | 1.4 | 1.8 | 1.0 | 1.0 |
| Thickness ratio T1/(T1 + T2 + T3) | 0.1 | 0.1 | 0.2 | 0.2 | 0.1 | 0.1 | — | — |
| Insulating properties (PDIV [V]) | 950 | 910 | 820 | 900 | 890 | 860 | 910 | 770 |
| Workability (PDIV [V]) | 850 | 860 | 800 | 860 | 830 | 760 | 750 | 750 |

Referring to Table 1, it is indicated that the magnet wires of Nos. 1 to 6 are excellent in insulating properties. Especially, it is indicated that the magnet wires of Nos. 1 to 5 are also excellent in workability.

### REFERENCE SIGNS LIST

1 conductor
2 insulating layer
2a innermost layer
2b outermost layer
2c intermediate layer
10, 20 magnet wire

1. A magnet wire comprising:
a conductor; and
a plurality of insulating layers covering the conductor, wherein
the insulating layers have an innermost layer and an outermost layer,
a main component of the innermost layer is a fluororesin, and
a ratio E1/E2 of a Young's modulus E1 of the outermost layer to a Young's modulus E2 of the innermost layer is 1.1 or more.

2. The magnet wire according to claim 1, wherein a ratio ε1/ε of a relative permittivity ε1 of the outermost layer to a relative permittivity ε of the insulating layers as a whole is from 1.1 to 2.0.

3. The magnet wire according to claim 1, wherein a main component of the outermost layer is polyimide, polyamide-imide, polyether ether ketone, polyphenylene sulfide, or a combination of these.

4. The magnet wire according to claim 1, wherein at least one of the innermost layer and the outermost layer contains silica.

5. The magnet wire according to claim 1, wherein the insulating layers further have an intermediate layer between the outermost layer and the innermost layer.

6. The magnet wire according to claim 5, wherein the intermediate layer contains silica.

7. The magnet wire according to claim 1, wherein the magnet wire is a rectangular wire.
